(19) United States
(12) Patent Application Publication
(10) Pub. No.: US 2025/0058947 A1
(43) Pub. Date: Feb. 20, 2025

(54) BASE FOR CONTAINER FORMED FROM RECYCLE POLYMERIC MATERIAL

(71) Applicant: AMCOR RIGID PACKAGING USA, LLC, Ann Arbor, MI (US)

(72) Inventors: Tyler M. NUNNOLD, Brighton, MI (US); Daniel FLOREZ-BEDOYA, Ann Arbor, MI (US); James STELZER, South Lyon, MI (US); John SICILIANO, Dexter, MI (US)

(21) Appl. No.: 18/717,821

(22) PCT Filed: Dec. 15, 2021
(86) PCT No.: PCT/US2021/072929

§ 371 Date: Jun. 7, 2024

(51) Int. Cl. B65D 65/38; B29C 49/00; B29C 49/12; B29K 67/00; B29K 105/26; B29L 31/00; B65D 1/02; B65D 1/40

(52) U.S. Cl. CPC B65D 65/38; B29C 49/071; B65D 1/0207; B65D 1/0276; B65D 1/40; B29C 49/12; B29C 2949/0747; B29C 2949/078; B29K 2067/003; B29K 2105/26; B29K 2995/004; B29L 2031/7158; B65D 2565/384

(57) ABSTRACT

A polymeric container with a finish defining an opening. A base is at an end of the polymeric container opposite to the opening. A plurality of base lobes are spaced apart about an axial center of the base. Each one of the plurality of base lobes includes a generally horizontal portion, a generally vertical portion, and a curved portion between the generally horizontal portion and the generally vertical portion. The polymeric container is made of at least 35% recycled material.

### FIELD

The present disclosure relates to a base for a container formed from recycled polymeric material.

### BACKGROUND

This section provides background information related to the present disclosure, which is not necessarily prior art.

As a result of environmental and other concerns, plastic containers, more specifically polyester and even more specifically polyethylene terephthalate (PET) containers, are now being used more than ever to package numerous commodities previously supplied in glass containers. Manufacturers and fillers, as well as consumers, have recognized that PET containers are lightweight, inexpensive, recyclable and manufacturable in large quantities.

Blow-molded plastic containers have become commonplace in packaging numerous commodities. PET is a crystallizable polymer, meaning that it is available in an amorphous form or a semi-crystalline form. The ability of a PET container to maintain its material integrity relates to the percentage of the PET container in crystalline form, also known as the “crystallinity” of the PET container. The following equation defines the percentage of crystallinity as a volume fraction:

$$\% Crystallinity = ( \frac{ρ - {ρ}_{α}}{{ρ}_{c} - {ρ}_{α}} ) \times 100$$

where ρ is the density of the PET material; pa is the density of pure amorphous PET material (1.333 g/cc); and pc is the density of pure crystalline material (1.455 g/cc).

Container manufacturers use mechanical processing and thermal processing to increase the PET polymer crystallinity of a container. Mechanical processing involves orienting the amorphous material to achieve strain hardening. This processing commonly involves stretching an injection molded PET preform along a longitudinal axis and expanding the PET preform along a transverse or radial axis to form a PET container. The combination promotes what manufacturers define as biaxial orientation of the molecular structure in the container. Manufacturers of PET containers currently use mechanical processing to produce PET containers having approximately 20% crystallinity in the container's sidewall.

Thermal processing involves heating the material (either amorphous or semi-crystalline) to promote crystal growth. On amorphous material, thermal processing of PET material results in a spherulitic morphology that interferes with the transmission of light. In other words, the resulting crystalline material is opaque, and thus, generally undesirable. Used after mechanical processing, however, thermal processing results in higher crystallinity and excellent clarity for those portions of the container having biaxial molecular orientation. The thermal processing of an oriented PET container, which is known as heat setting, typically includes blow molding a PET preform against a mold heated to a temperature of approximately 250° F.-350° F. (approximately 121° C.-177° C.), and holding the blown container against the heated mold for approximately two (2) to five (5) seconds. Manufacturers of PET juice bottles, which must be hot-filled at approximately 185° F. (85° C.), currently use heat setting to produce PET bottles having an overall crystallinity in the range of approximately 25%-35%.

While current preforms and containers are suitable for their intended use, they are subject to improvement. The present disclosure provides for improved preforms and containers, which advantageously include recycled content.

### SUMMARY

This section provides a general summary of the disclosure, and is not a comprehensive disclosure of its full scope or all of its features.

The present disclosure includes a polymeric container with a finish defining an opening. A base is at an end of the polymeric container opposite to the opening. A plurality of base lobes are spaced apart about an axial center of the base. Each one of the plurality of base lobes includes a generally horizontal portion, a generally vertical portion, and a curved portion between the generally horizontal portion and the generally vertical portion. The polymeric container is made of at least 35% recycled material.

The present disclosure further includes a polymeric container with a finish defining an opening. A base is at an end of the polymeric container opposite to the opening. A plurality of base lobes are included with the base and spaced apart about an axial center of the base. A 1.0 mm-2.0 mm deep (i.e., recessed) circular outer edge of the base surrounds the plurality of base lobes. An outer end of each one of the plurality of base lobes contacts the circular outer edge. Each one of the plurality of base lobes includes a generally horizontal portion, a generally vertical portion, and a curved portion between the generally horizontal portion and the generally vertical portion. The plurality of base lobes are 54%-57% of a total surface area of the base within the circular outer edge surrounding the plurality of base lobes. The polymeric container is made of at least 35% recycled material.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of select embodiments and not all possible implementations, and are not intended to limit the scope of the present disclosure.

FIG. 1 is a perspective view of a container including a base in accordance with the present disclosure;

FIG. 2 is a perspective view of the base of the container of FIG. 1;

FIG. 3 is a cross-sectional view taken along 3-3 of FIG. 2;

FIG. 4 is a cross-sectional view taken along line 4-4 of FIG. 2;

FIG. 5 is a plan view of the base according to the present disclosure of the container of FIG. 1;

FIG. 6 is a perspective view of one a plurality of lobes included with the base of the container of FIG. 1;

FIG. 7 is a perspective view of a generally horizontal portion of one of the plurality of lobes included with the base of the container of FIG. 1; and

FIG. 8 is a plan view of FIG. 7.

Corresponding reference numerals indicate corresponding parts throughout the several views of the drawings.

### DETAILED DESCRIPTION

Example embodiments will now be described more fully with reference to the accompanying drawings.

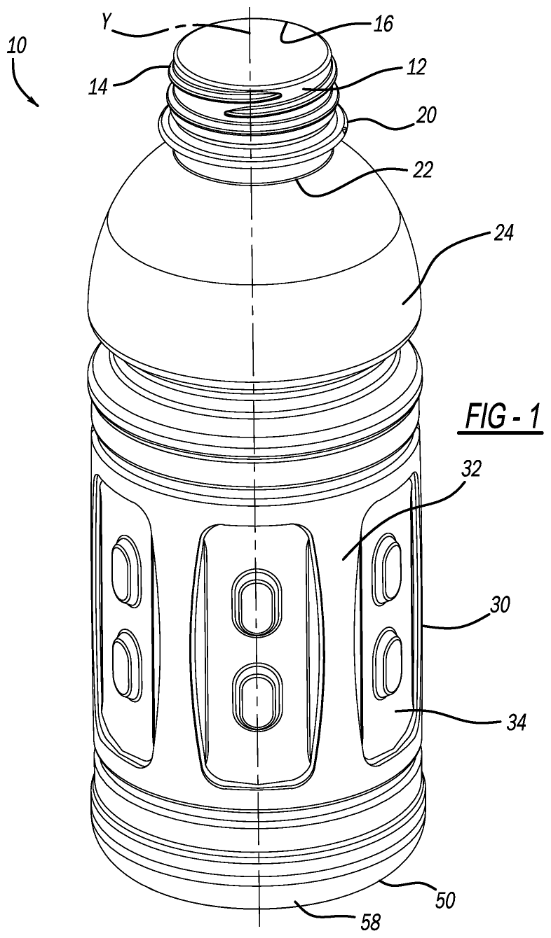

With initial reference to FIG. 1, a polymeric container in accordance with the present disclosure is illustrated at reference numeral 10. The container 10 is a heat-set container configured for storing any suitable hot-fill products. Exemplary products that the container 10 is configured to store include, but are not limited to, juice, sport drinks, food, etc. The container 10 may be made of polyethylene terephthalate (PET). The container 10 is advantageously formed of recycled polymeric material, such as at least 35% recycled polymeric material. In some applications, the container 10 may be made of at least 50% recycled polymeric material, 75% recycled polymeric material, or up to 100% recycled polymeric material. Suitable recycled polymeric materials include recycled polyethylene terephthalate (rPET).

The container 10 may have any suitable size and shape. For example, the container 10 may have a square shape as illustrated in FIG. 1, may be rectangular, circular, polygonal, etc. Regardless of the overall shape of the container 10, the base 50 will be circular, as described further herein.

The container 10 generally includes a finish 12 at an upper end of the container 10. Extending outward from the finish 12 are a plurality of threads 14, which are configured in any suitable manner to cooperate with any suitable closure for closing the opening 16 of the container 10. The opening 16 is defined by the finish 12.

Beneath the finish 12 is a flange 20 extending outward around the container 10. Beneath the flange 20 is a neck 22, which extends downward to a shoulder 24. The shoulder 24 tapers outward as the shoulder 24 extends away from the neck 22. The shoulder 24 extends to a body 30 of the container 10. The body 30 includes a plurality of sidewalls 32. The container 10 of FIG. 1 includes four sidewalls 32. The sidewalls 32 may optionally include one or more vacuum panels 34.

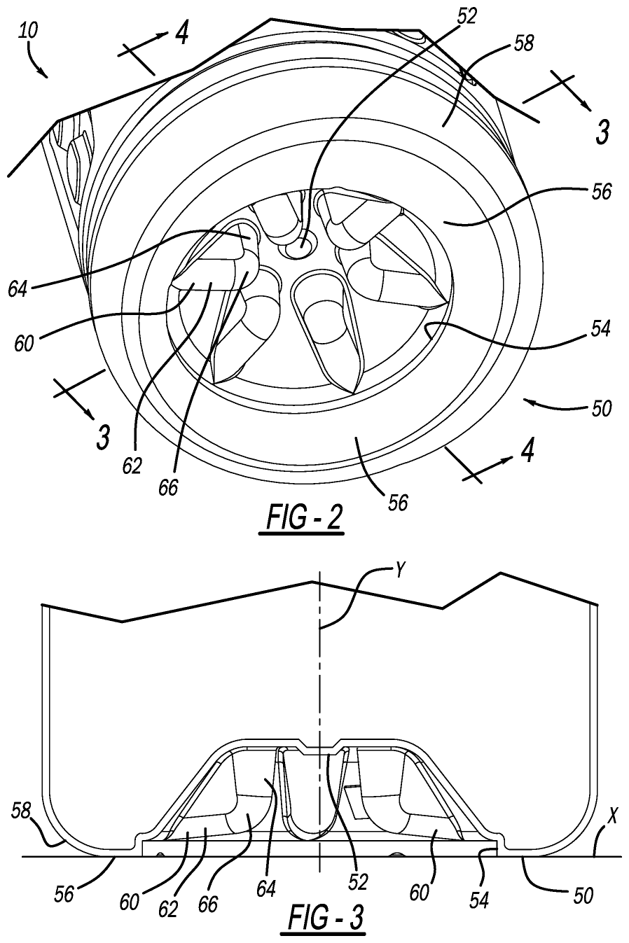

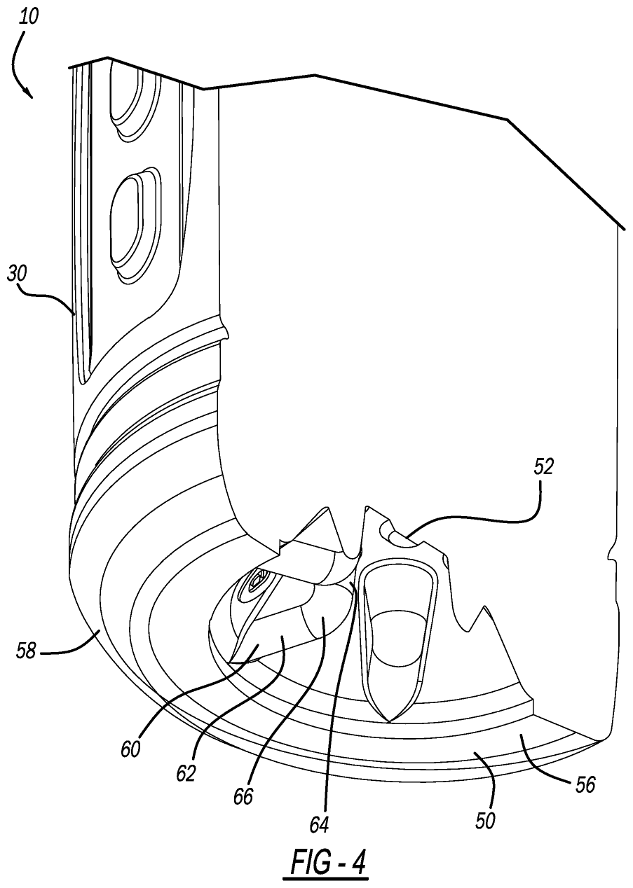

At an end of the body 30 opposite to the shoulder 24 is a base 50. With additional reference to FIGS. 2-8, the base 50 will now be described in detail. The base 50 has a center portion 52 at an axial center thereof. A longitudinal axis Y of the container 10 extends along an axial center of the container 10 and through the axial center of the base 50 at the center portion 52. The longitudinal axis y also extends through an axial center of the opening 16.

The base 50 further includes a circular outer edge 54, which is circular regardless of the shape of the body 30. The outer edge 54 has a depth of 1.0 mm-2.0 mm, or about 1.5 mm, which reduces or eliminates the risk of amorphous material extending beyond the central portion 52 to the planer surface 56, which may cause distortion and roll-out of the base 50, which may limit production rates.

Outward of the circular outer edge 54 is a planar surface 56 of the base 50. The planar surface 56 extends generally perpendicular to the longitudinal axis Y between the circular outer edge 54 and a heel 58 of the base 50. The heel 58 extends from the planar surface 56 to the body 30. The planar surface 56 extends between the circular outer edge 54 and the heel 58 along a horizontal plane X, which is perpendicular to the longitudinal axis Y.

The base 50 further includes a plurality of base lobes 60. The base lobes 60 are evenly spaced apart about the center portion 52 of the base 50. Any suitable number of the base lobes 60 may be included. For example, and as illustrated in the exemplary drawings, six of the base lobes 60 may be included.

Each one of the base lobes 60 includes a horizontal portion 62, which is a generally horizontal portion extending generally horizontal to the horizontal plane X. In the examples illustrated, the horizontal portion 62 is angled slightly inward in a direction of the finish 12. Each one of the base lobes 60 also includes a vertical portion 64. The vertical portion 64 is a generally vertical portion extending generally vertical to the longitudinal axis Y, as explained further herein. Between the horizontal portion 62 and the vertical portion 64 is a curved portion 66, which may be considered an elbow portion.

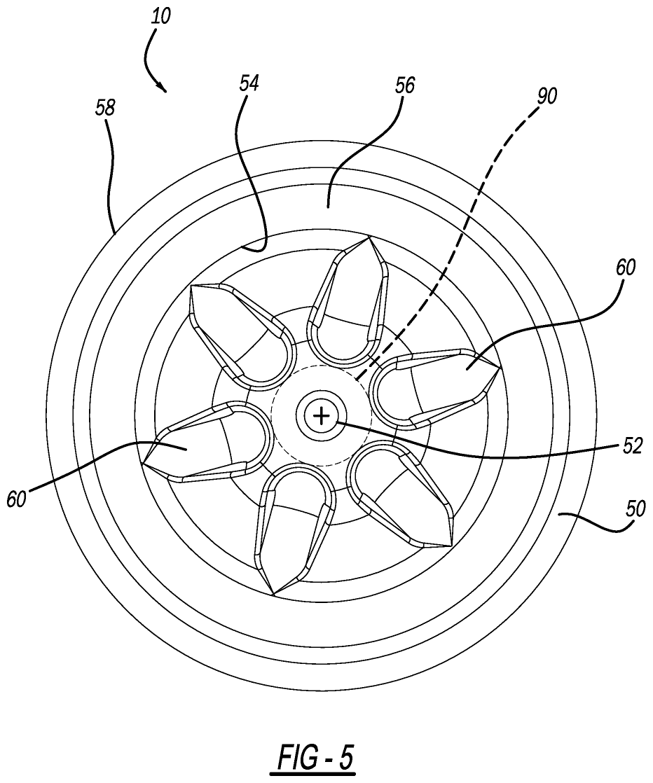

The plurality of base lobes 60 are spaced apart from the center portion 52 to define a center clearance diameter 90, as illustrated in FIG. 5 for example. The center clearance diameter 90 is configured to accommodate a counter-stretch rod, and thus serves as a counter-stretch rod receptacle. During forming of the base 50, a counter-stretch rod extends through a base mold to contact the base 50 at the center clearance diameter 90. The center clearance diameter 90 is configured to accept a counter-stretch rod having a diameter of 11-14 mm, for example.

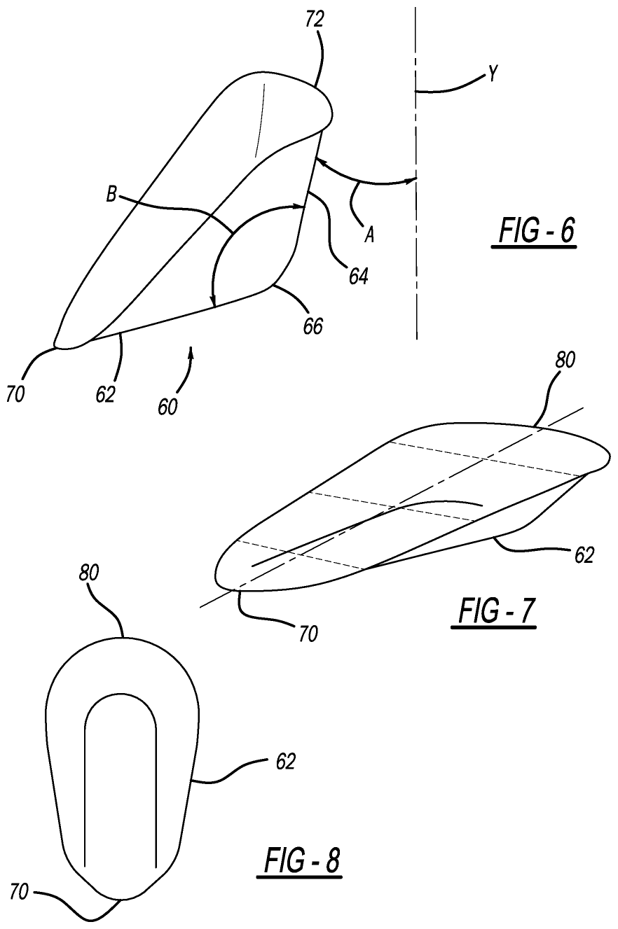

With particular reference to FIGS. 6-8, one of the base lobes 60 is illustrated. All of the base lobes 60 are the same or substantially similar, and thus the illustration of the base lobe 60 in FIGS. 6-8, and the following description, applies to all of the base lobes 60. Each one of the base lobes 60 includes an outer end 70, which is near or adjacent to the circular outer edge 54. The outer end 70 is also an outer end of the generally horizontal portion 62. Each base lobe 60 further includes an inner end 72, which is proximate to the center portion 52 and adjacent to the center clearance diameter 90. The inner ends 72 of the base lobes 60 together partially define the center clearance diameter 90.

With particular reference to FIG. 6, the generally vertical portion 64 is angled relative to the longitudinal axis Y at a first lobe angle A. The first lobe angle A may be about 5°. The generally vertical portion 64 is angled relative to the generally horizontal portion 62 at a second lobe angle B. The second lobe angle B may be about 100°.

With particular reference to FIGS. 7 and 8, the generally horizontal portion 62 of each one of the lobes 60 further includes an inner end 80, which is generally where the horizontal portion 62 meets the curved portion 66. Each one of the horizontal portions 62 is tapered from the inner end 80 to the outer end 70 such that each one of the generally horizontal portions 62 is most narrow at the outer end 70, and most wide at the inner end 80.

The base 50 provides numerous advantages. For example, the base 50 has a total base surface area, including the plurality of base lobes 60, that is 2%-8%, or about 6%, greater than existing bases. The base 50 has an increased surface area of the base lobes 60 that is 12%-16%, or about 15%, greater than lobes of existing bases. The base 50, as compared to existing bases, has an increased lobe percentage of the base surface area resulting in the plurality of base lobes 60 being 54%-57%, or about 56%, of an overall surface area of the base 50.

The base 50 may be configured with any suitable dimensions. For example, the base 50 may include any of the following exemplary dimensions (total base surface area is the area within the circular outer edge 54):

| | Total | | | | | |
|---|---|---|---|---|---|---|
| | Base | Total | | Lobe | First | Second |
| Container | Surface | Lobe | | Clearance | Lobe | Lobe |
| Diameter | Area | Area | Lobe % | Diameter | Angle | Angle |
| (mm) | (mm²) | (mm²) | of S/A | (mm) | A (°) | B (°) |
| 68 | 28.369 | 15.386 | 54% | 10.8 | 5 | 100 |
| 72 | 32.983 | 18.119 | 55% | 10.8 | 5 | 100 |
| 76 | 37.927 | 21.043 | 55% | 10.8 | 5 | 100 |
| 80 | 43.855 | 23.967 | 55% | 11.303 | 5 | 100 |
| 84 | 47.765 | 26.9 | 56% | 12.2 | 5 | 100 |
| 88 | 52.943 | 29.998 | 57% | 13.112 | 5 | 100 |
| 92 | 58.389 | 33.263 | 57% | 14.017 | 5 | 100 |

The present disclosure advantageously provides for a base 50 that addresses various performance and manufacturing issues experienced in existing bases when existing bases are attempted to be formed from recycled polymeric material, and specifically recycled thermoplastic material blended with virgin material to form an injection molded preform that is stretch blow molded into a final container. The advantages of the base 50 of the present disclosure include improved base blow molding consistency, better centering of the preform injection gate during blow molding, and improved control over material distribution in the base and body of the container. This allows for higher preform processing temperatures, which promotes higher crystallinity in the thermoplastic material, and provides for a more robust container able to withstand the stresses caused by the hot-fill process, such as bloating, base roll-outs, and general deformations. The configuration of the base 50 advantageously allows for the crystallinity of the entire container 10 to be increased. For example and with respect to a mid-portion of the sidewall 32, the crystallinity is 27-31%, or about 29%, which is a 21% improvement over prior containers that only have a crystallinity of about 24%. The base 50 also provides for improved waviness, and reduced under blow/shrink-back in the standing surface. The configuration of the base 50 of the present disclosure further allows for processing at a higher temperature, such as at about 98° C.-107° C. By penetrating the preform with additional heat, approximately 4% more material is moved into the vacuum panels 34 (such as from 5.5 g to 5.7 g on average) making the vacuum panels 34 more resistant to expansion under hot-fill pressure. The container 10 including the base 50 of the present disclosure advantageously has a 21% improvement in crystallinity values at the vacuum panels 34 of the container 10. One skilled in the art will appreciate that the present disclosure provides for numerous additional advantages as well.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A polymeric container comprising:
a finish defining an opening;
a base at an end of the polymeric container opposite to the opening;
a plurality of base lobes included with the base and spaced apart about an axial center of the base; and
a counter-stretch rod receptacle at an axial center of the base and defined by the plurality of base lobes, the counter-stretch rod receptacle is configured to receive a counter-stretch rod of a blow-molding machine during formation of the polymeric container; and
wherein the polymeric container is made of at least 35% recycled material.

2. The polymeric container of claim 1, wherein the polymeric container is made of polyethylene terephthalate.

3. The polymeric container of claim 1, wherein the recycled material is recycled polyethylene terephthalate.

4. The polymeric container of claim 1, wherein the counter-stretch rod receptacle has a diameter of 11-14 mm.

5. The polymeric container of claim 1, wherein the base is molded at a temperature of about 98° C.-107° C.

6. The polymeric container of claim 1, wherein the polymeric container has a crystallinity of 27%-31%.

7. A polymeric container comprising:
a finish defining an opening;
a base at an end of the polymeric container opposite to the opening;
a plurality of base lobes included with the base and spaced apart about an axial center of the base; and
a circular outer edge of the base surrounding the plurality of base lobes, an outer end of each one of the plurality of base lobes contacts the circular outer edge;
wherein each one of the plurality of base lobes includes a generally horizontal portion, a generally vertical portion, and a curved portion between the generally horizontal portion and the generally vertical portion;
wherein the plurality of base lobes are 54%-57% of a total surface area of the base within the circular outer edge surrounding the plurality of base lobes; and
wherein the polymeric container is made of at least 35% recycled material.

8. The polymeric container of claim 7, wherein the polymeric container is made of polyethylene terephthalate.

9. The polymeric container of claim 7, wherein the recycled material is recycled polyethylene terephthalate.

10. The polymeric container of claim 1, wherein the polymeric container is made of at least 50% recycled polymeric material.

11. The polymeric container of claim 1, wherein the polymeric container is made of at least 75% recycled polymeric material.

12. The polymeric container of claim 1, wherein the polymeric container is made of 100% recycled polymeric material.

13. The polymeric container of claim 1, wherein the generally vertical portion is at an angle of about 5° relative to a longitudinal axis extending along an axial center of the polymeric container.

14. The polymeric container of claim 1, wherein the generally vertical portion and the generally horizontal portion are at an angle of about 100° relative to each other.

15. The polymeric container of claim 1, where the circular outer edge has a depth of 1-2 mm.

16. The polymeric container of claim 1, wherein the circular outer edge has a depth of 1.5 mm.

17. The polymeric container of claim 1, further comprising a counter-stretch rod receptacle at an axial center of the base and defined by the plurality of base lobes, the counter-stretch rod receptacle is configured to receive a counter-stretch rod of a blow-molding machine during formation of the polymeric container.

18. The polymeric container of claim 17, wherein the counter-stretch rod receptacle has a diameter of 11-14 mm.

19. The polymeric container of claim 1, wherein the generally horizontal portion is most narrow at the circular outer edge of the base.

20. The polymeric container of claim 19, wherein the generally horizontal portion tapers outward from the circular outer edge of the base towards an axial center of the base.

21. The polymeric container of claim 1, wherein the base is molded at a temperature of about 98° C.-107° C.

22. The polymeric container of claim 1, wherein the polymeric container has a crystallinity of 27%-31%.

23. The polymeric container of claim 1, wherein the polymeric container has a crystallinity of about 29%.

24. A polymeric container comprising:
a finish defining an opening;
a base at an end of the polymeric container opposite to the opening; and
a plurality of base lobes included with the base and spaced apart about an axial center of the base; and
a circular outer edge of the base surrounding the plurality of base lobes, the circular outer edge has a depth of 1 mm-2 mm, an outer end of each one of the plurality of base lobes contacts the circular outer edge;
wherein:
each one of the plurality of base lobes includes a generally horizontal portion, a generally vertical portion, and a curved portion between the generally horizontal portion and the generally vertical portion;
the generally vertical portion is at an angle of 5° relative to a longitudinal axis extending along an axial center of the polymeric container;
the generally vertical portion and the generally horizontal portion are at an angle of about 100° relative to each other;
the plurality of base lobes are 54%-57% of a total surface area of the base within the circular outer edge surrounding the plurality of base lobes;
the polymeric container has a crystallinity of 27-31%; and
the polymeric container is made of at least 35% recycled material.

25. The polymeric container of claim 24, wherein the polymeric container is made of polyethylene terephthalate.

26. The polymeric container of claim 24, wherein the recycled material is recycled polyethylene terephthalate.

27. The polymeric container of claim 24, wherein the circular outer edge has a depth of about 1.5 mm.

28. The polymeric container of claim 24, wherein the polymeric container is made of at least 50% recycled polymeric material.

29. The polymeric container of claim 24, wherein the polymeric container is made of 100% recycled polymeric material.

30. The polymeric container of claim 24, further comprising a counter-stretch rod receptacle at the axial center of the base and defined by the plurality of base lobes, the counter-stretch rod receptacle is configured to receive a counter-stretch rod of a blow-molding machine during formation of the polymeric container.

31. The polymeric container of claim 30, wherein the counter-stretch rod receptacle has a diameter of 11-14 mm.

32. The polymeric container of claim 24, wherein the generally horizontal portion is most narrow at the circular outer edge of the base.

33. The polymeric container of claim 24, wherein the generally horizontal portion tapers outward from the circular outer edge of the base towards the axial center of the base.

34. The polymeric container of claim 24, wherein the base is molded at a temperature of about 98° C.-107° C.

35. The polymeric container of claim 24, wherein the base has a crystallinity of about 29%.
